(19) United States
(12) Patent Application Publication
(10) Pub. No.: US 2024/0403977 A1
(43) Pub. Date: Dec. 5, 2024

(54) SOLAR MONITORING SYSTEMS, DEVICES, AND METHODS

(71) Applicant: Solar Unsoiled, Inc., Durham, NC (US)

(72) Inventor: Michael Valerino, Durham, NC (US)

(21) Appl. No.: 18/680,642

(22) Filed: May 31, 2024

Related U.S. Application Data
(60) Provisional application No. 63/469,962, filed on May 31, 2023.

(51) Int. Cl. G06Q 50/02; F24S 21/00; F24S 80/00; G06Q 10/04; G06T 7/00

(52) U.S. Cl. CPC G06Q 50/02; F24S 21/00; F24S 80/00; G06Q 10/04; G06T 7/0004; G06T 7/97; F24S 2201/00; G06T 2207/20081; G06T 2207/20084; G06T 2207/20221

(57) ABSTRACT

A method of estimating soiling losses is described herein, which according to one implementation includes generating an image of a surface of a solar panel; inputting the image of a surface of the solar panel into a model; analyzing the image of a surface of the solar panel to determine an estimate of soiling losses; and outputting the estimate of soiling losses.

### CROSS-REFERENCE TO RELATED APPLICATIONS

This application claims the benefit of U.S. provisional patent application No. 63/469,962, filed on May 31, 2023, and titled “SOLAR MONITORING SYSTEMS, DEVICES, AND METHODS,” the disclosure of which is expressly incorporated herein by reference in its entirety.

### BACKGROUND

Photovoltaic solar panels can be used to generate electricity by converting light to electrical current. Solar panels can be made using arrays of solar cells. The solar cells can each include a semiconductor device that generates electrical current when exposed to sunlight. The solar panels can include a transparent coating (e.g., glass or plastic) to protect the array of solar cells and other electronics. Solar panels can be affected by energy losses due to environmental conditions.

### SUMMARY

In some aspects, implementations of the present disclosure include a computer-implemented method of analyzing soiling losses, the method including: receiving an image of a surface of a solar panel; analyzing the image to determine an estimate of soiling losses; and outputting the estimate of soiling losses.

In some aspects, implementations of the present disclosure include a computer-implemented method, further including at least one of forecasting energy production from the solar, assessing performance of the solar panel, and instructing a user to clean the solar panel or when to clean the solar panel.

In some aspects, implementations of the present disclosure include a computer-implemented method, wherein the image is a digital microscope image.

In some aspects, implementations of the present disclosure include a computer-implemented method, further including displaying the estimate of soiling losses to a user.

In some aspects, implementations of the present disclosure include a computer-implemented method, further including storing the estimate of soiling losses to a database.

In some aspects, implementations of the present disclosure include a system for analyzing soiling losses, the system including: a digital microscope; and a computing device in operable communication with the digital microscope, wherein the computing device includes a processor and a memory, the memory having computer-executable instructions stored thereon that, when executed by the processor, cause the processor to: receive an image of a surface of a solar panel from the digital microscope; analyze the image to determine an estimate of soiling losses; and output the estimate of soiling losses.

In some aspects, implementations of the present disclosure include a method for analyzing soiling losses, the method including: generating an image of a surface of a solar panel; inputting the image of a surface of the solar panel into a model; analyzing, using the model, the image of a surface of the solar panel to determine an estimate of soiling losses; and outputting, from the model, the estimate of soiling losses.

In some aspects, implementations of the present disclosure include a method, wherein the image is a digital microscope image.

In some aspects, implementations of the present disclosure include a method, further including displaying the estimate of soiling losses to a user.

In some aspects, implementations of the present disclosure include a method, further including storing the estimate of soiling losses to a database.

In some aspects, implementations of the present disclosure include a method, wherein the estimate of soiling losses includes an estimate of future soiling losses.

In some aspects, implementations of the present disclosure include a method of training a machine learning model to estimate soiling losses, the method including: receiving training data including a plurality of images and corresponding soiling estimations for the plurality of images; preprocessing the training data; and training a machine learning model to estimate soiling loss based on at least the preprocessed training data.

In some aspects, implementations of the present disclosure include a method, wherein the soiling loss includes at least one of particle size, mass loading or area loading.

In some aspects, implementations of the present disclosure include a method, wherein the soiling loss includes an estimate of power loss.

In some aspects, implementations of the present disclosure include a method, wherein the machine learning model is a convolutional neural network.

In some aspects, implementations of the present disclosure include a method, wherein preprocessing the training data includes performing random flips on one or more images.

In some aspects, implementations of the present disclosure include a method, wherein preprocessing the training data includes a performing thresholding operation on the plurality of images.

In some aspects, implementations of the present disclosure include a method, wherein preprocessing the training data includes aggregating at least two of the plurality of images into a composite image.

In some aspects, implementations of the present disclosure include a method, wherein preprocessing the training data includes converting the plurality of images into binary images.

In some aspects, implementations of the present disclosure include a method, wherein preprocessing the training data includes determining a plurality of pixel values for the plurality of images.

In some aspects, an implementation of the present disclosure includes receiving, at a computing device, an image of a surface of a photovoltaic panel; analyzing, using the computing device, the image to determine an estimate of soiling losses; outputting, using the computing device, the estimate of soiling losses; and in response to the estimate of soiling losses cleaning the photovoltaic panel or determining when to clean the photovoltaic panel.

In some aspects, an implementation of the present disclosure includes receiving, at a computing device, an image of a surface of a photovoltaic panel; analyzing, using the computing device, the image to determine an estimate of soiling losses; outputting, using the computing device, the estimate of soiling losses; and in based on the estimate of soiling losses performing at least one of: modeling, performance analysis, reporting and/or display.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1A illustrates a method for analyzing soiling losses of a photovoltaic panel, according to an example implementation of the present disclosure.

FIG. 1B illustrates a method for analyzing soiling losses of a photovoltaic panel, according to an example implementation of the present disclosure.

FIG. 1C illustrates an example method of image analysis, according to an example implementation of the present disclosure.

FIG. 1D illustrates an example method of image analysis, according to an example implementation of the present disclosure.

FIG. 2A illustrates an example device and system for analyzing soiling losses of a photovoltaic panel.

FIG. 2B illustrates an example system for measuring soiling losses, according to implementations of the present disclosure.

FIG. 3 is an exemplary computer system suitable for implementing several embodiments of the disclosure.

FIG. 4A illustrates an example method of training a machine learning model to estimate soiling losses, according to implementations of the present disclosure.

FIG. 4B illustrates an example method of estimating soiling losses using a machine learning model, according to implementations of the present disclosure.

FIG. 5A illustrates an unprocessed image that can be output by a microscopy device, according to implementations of the present disclosure.

FIG. 5B illustrates the image of FIG. 5A, converted to be an 8-bit image, according to implementations of the present disclosure.

FIG. 5C illustrates an example thresholded image obtained by applying an example thresholding operation to FIG. 5B, according to implementations of the present disclosure.

FIG. 5D illustrates an output of thresholding for particle identification/isolation, according to implementations of the present disclosure.

FIG. 5E illustrates example estimates of the areas of particles identified in the thresholded image of FIG. 5D, according to implementations of the present disclosure.

FIG. 6A illustrates an example unprocessed image that can be output by a microscopy device, according to implementations of the present disclosure.

FIG. 6B illustrates a second example of a thresholded image using the unprocessed image shown in FIG. 6A, according to implementations of the present disclosure.

FIG. 6C illustrates an example fill holes operation applied to the thresholded image of FIG. 6B, according to implementations of the present disclosure.

FIG. 6D illustrates an example watershed operation applied to the image of FIG. 6C.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents. Use of the phrase “and/or” indicates that any one or any combination of a list of options can be used. For example, “A, B, and/or C” means “A”, or “B”, or “C”, or “A and B”, or “A and C”, or “B and C”, or “A and B and C”.

Photovoltaic panels convert light into electricity. In an example photovoltaic panel, photons hit a semiconductor material, and the semiconductor releases electrons that can form electric currents and potentials, which can be used as electrical energy. The greater the number of photons that hit the semiconductor, the more energy is produced, and therefore the more efficient the solar panel is at converting a source of photons into electricity. It should be understood that while “photovoltaic” semiconductor-base panels are described as illustrative examples, the techniques described herein can be applied to any type of photovoltaic device, non-limiting examples of which include: mono crystalline, poly crystalline, thin film, cadmium telluride, etc.

A common source of photons is the sun, and photovoltaic solar panels are commonly placed outdoors as “solar panels” to convert sunlight into energy. But solar panels are subject to contaminants in the outdoor environment that reduce the number of photons that reach the semiconductor, and thereby reduce the efficiency of the photovoltaic panel. Examples of contaminants that can reduce the efficiency of solar panels include: dust, debris, air pollution, pollen, fungal/biological growth or other debris stopping light from effectively being converted to electrical power.

As yet additional examples, air pollution as used herein can include both naturally-occurring (trees, volcanoes, wildfires, etc.) and anthropogenically-generated (car emission, factory emissions, dust kicked up by construction, oil leaking from a wind turbine, etc.). Non-limiting examples of debris can include any coating, including oil, concrete dust, mold growth, carbon film, tree sap, etc.

As still additional examples, contaminants can include chemical, physical, and/or biological reactions that occur on the surface of the panel, and thereby damage the surface of a photovoltaic panel, otherwise contaminate the surface of the solar panel by forming other compounds.

The losses caused by any or all of these contaminants can be referred to as “soiling losses.” Soiling losses can affect the amount of current that is generated by the solar cells, and therefore reduce the efficiency of the solar panel. Examples of types of soiling loss include: direct current performance loss, direct current weather adjusted performance loss, direct current energy generation loss, short circuit current loss, open circuit voltage loss, maximum power point loss, panel efficiency loss, AC (invert-level) generation loss, economic losses of missing power generation, and/or overall site power loss. Examples of how soiling loss can be calculated include: percentage (e.g., calculated from percentage loss and/or a percentage remaining); ratio (e.g., 0.003 or 0.97); proportion or percentage of maximum theoretical loss/output, or loss relative to a particular baseline amount; and/or rate of degradation/loss (e.g., hourly, daily, monthly, etc.). It should be understood that soiling losses can be measured based on any performance metric of the solar panel, and the particular measures descried herein are only non-limiting examples.

Implementations of the present disclosure are directed to systems, methods, and devices for improving the measuring, analyzing, and/or predicting soiling losses of photovoltaics including solar panels. Accurate measurement of soiling losses can be used to forecast energy production, assess current site performance, and determine if/when cleaning should take place. The present disclosure allows for replicable/unbiased measures of soiling on photovoltaics, and thereby improves power generation from photovoltaics by improving the cleaning/maintenance of photovoltaics.

Additionally, implementations of the present disclosure can be adjustable for different types of panels using different physical structures (e.g., white spaces in crystalline panels or dark backgrounds in thin-film panels).

Additionally, implementations of the present disclosure can be used for analysis of panel performance and panel environment. For example, the distribution and type of contaminants detected can be used to analyze the effect of photovoltaic surface coatings and/or determine the type of particles on the surface (which, in turn, can be used to estimate or determine physical processes that cause the soiling).

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

Machine learning models may include artificial neural networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation.

A convolutional neural network (CNN) is a type of deep neural network that has been applied, for example, to image analysis applications. Unlike a traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks.

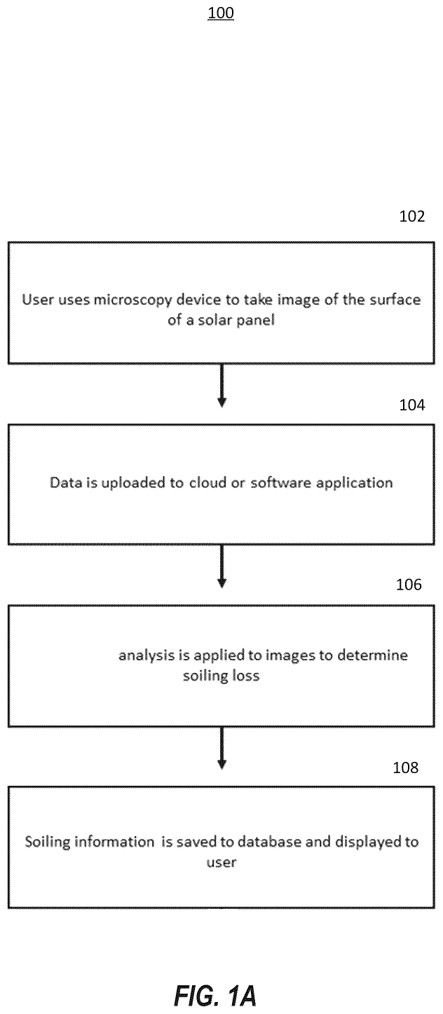

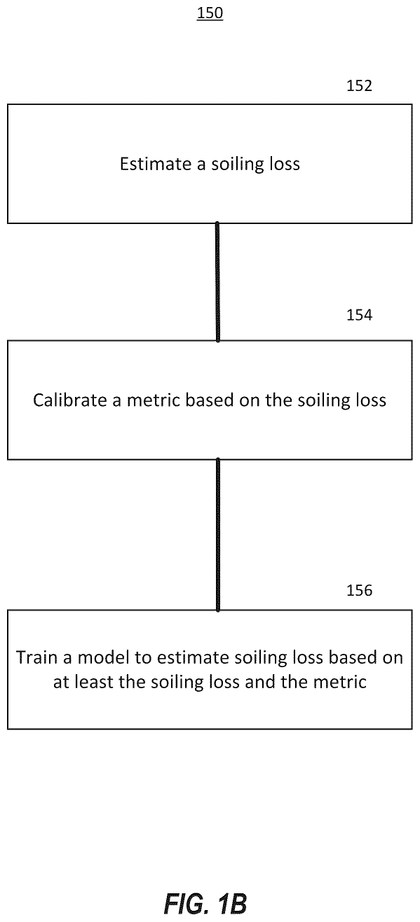

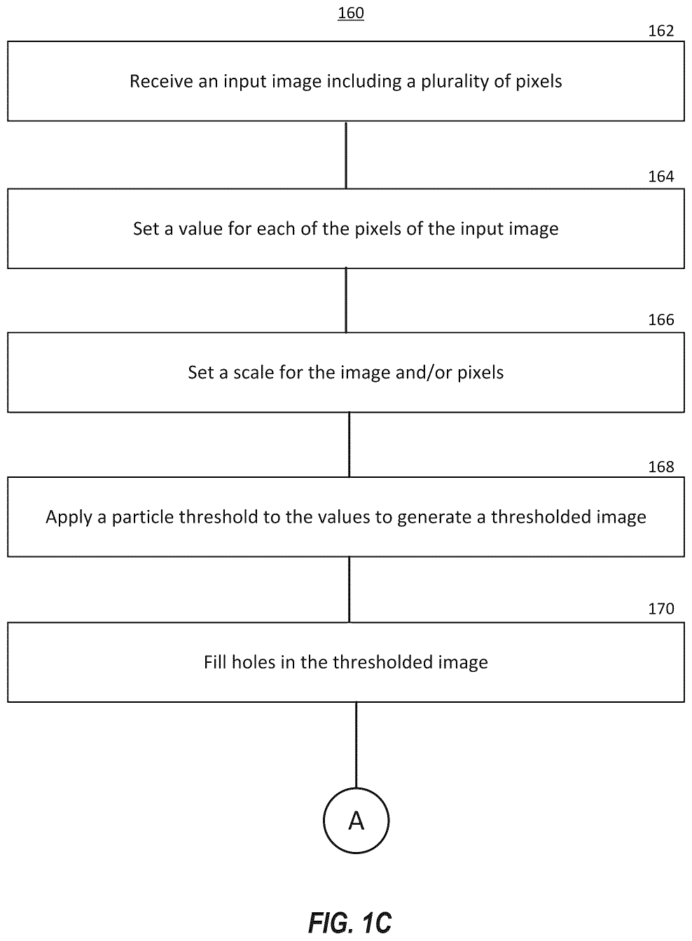

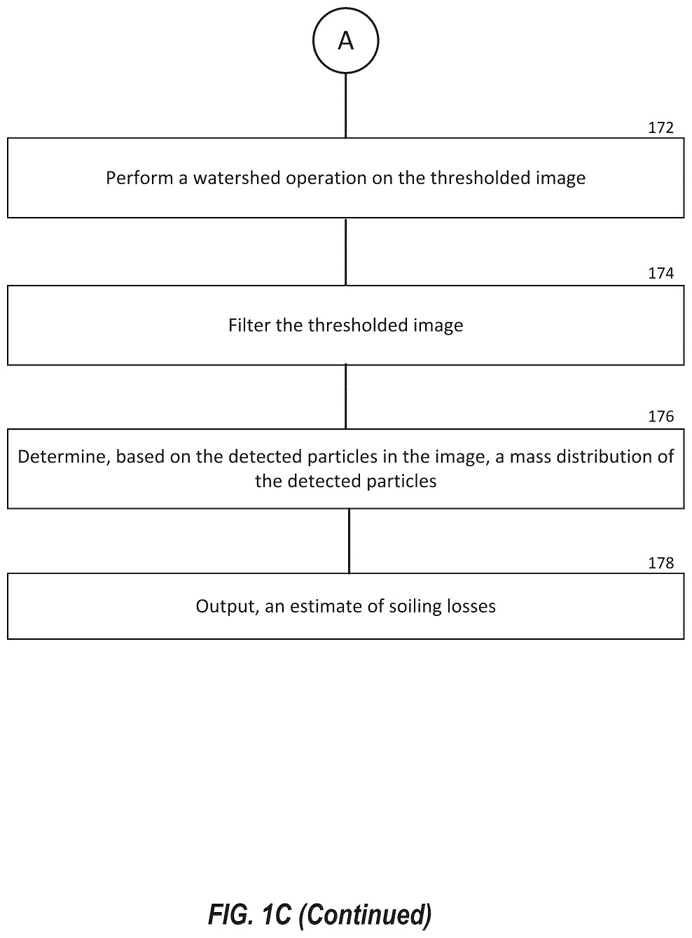

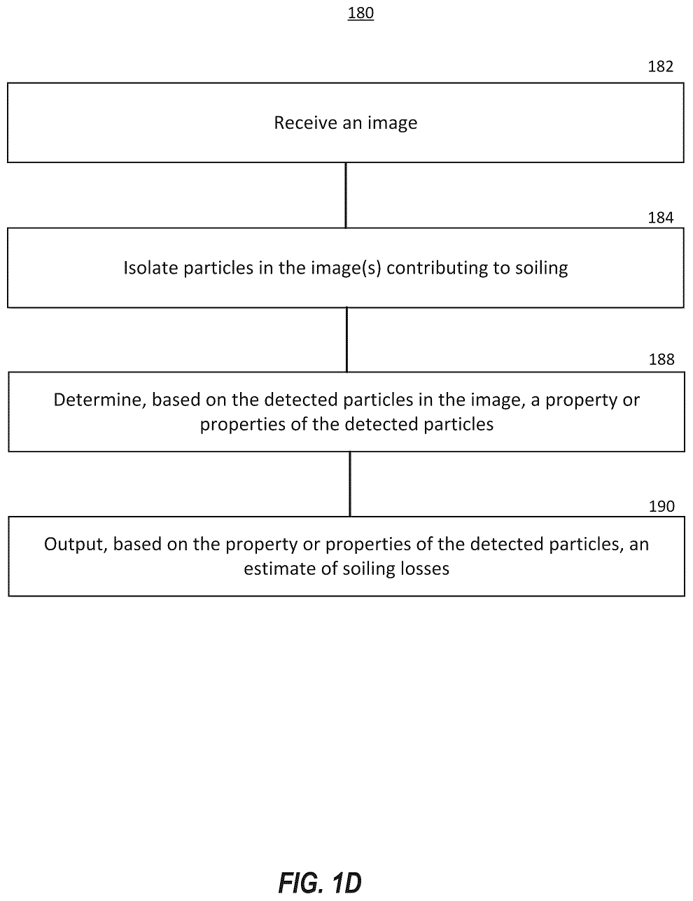

With reference to FIG. 1A, an example method 100 of measuring the soiling and/or soiling losses of solar panels is shown.

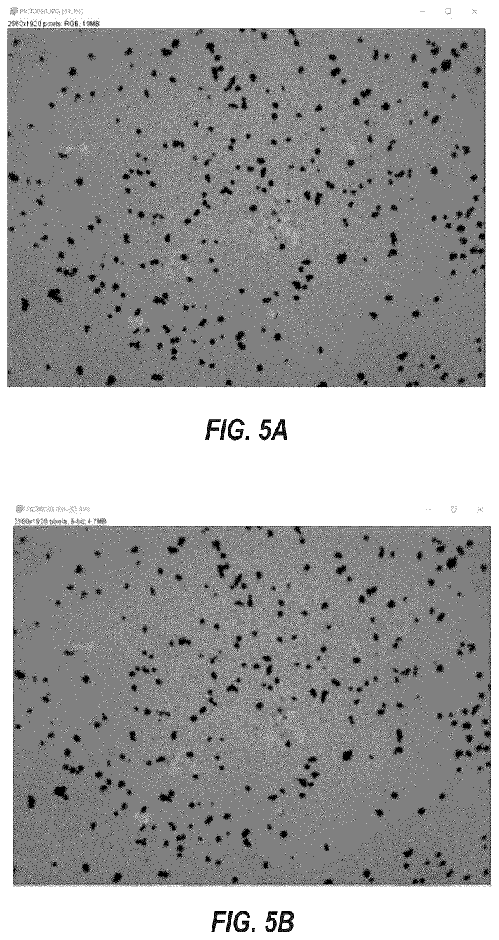

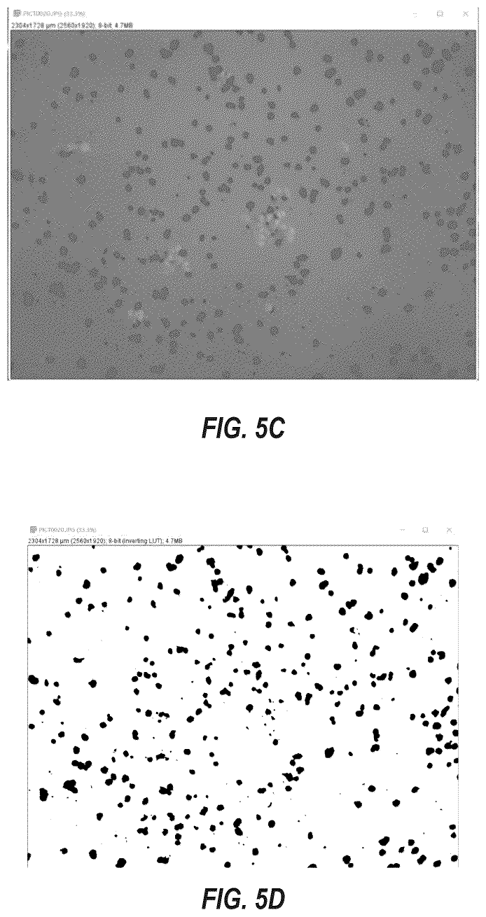

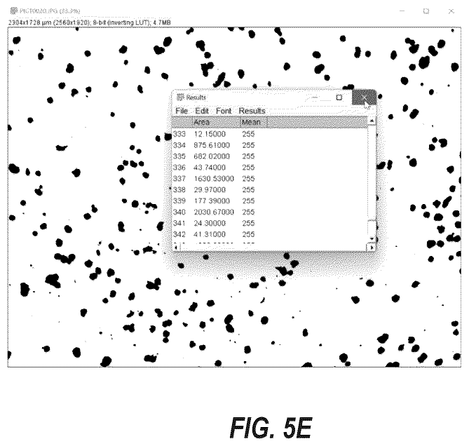

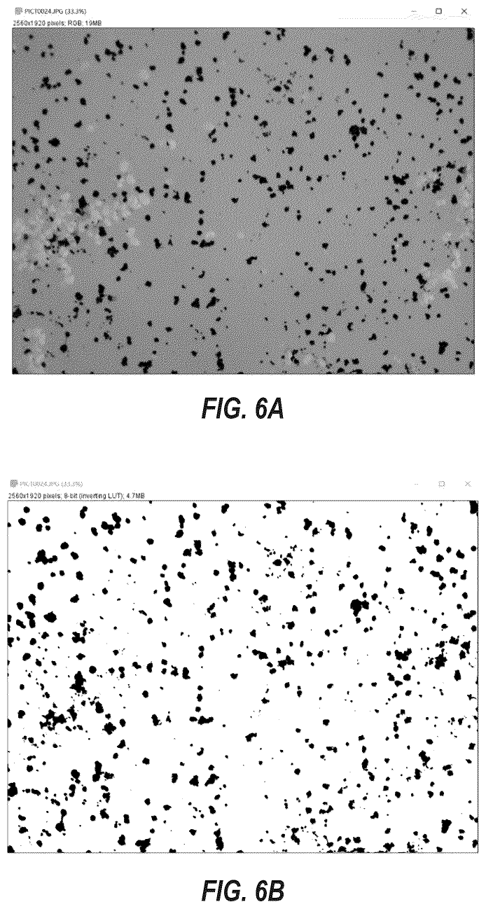

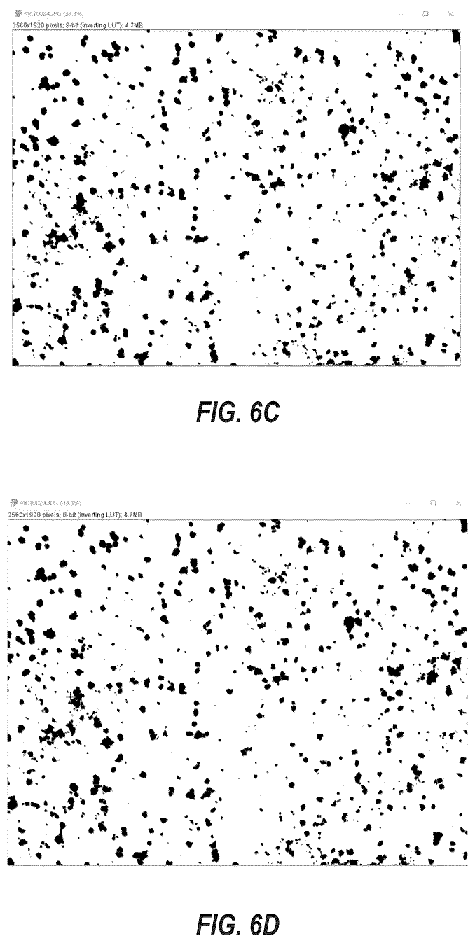

At step 102, a microscopy device is used to take an image of the surface of a solar panel. It should be understood that the image can be an image in any file format, non-limiting examples include .tiff, .jpg, .png, .pdg, etc. It should also be understood that the image can be an image including different types of pixels. Optionally, the image can be color, black and white, and/or binary (pixels are given one of two values). As another example, the image can include values measuring or describing a lightness/darkness value of one or more pixels. Non-limiting examples of images that can be captured by a microscopy device are shown in FIGS. 5A and 6A.

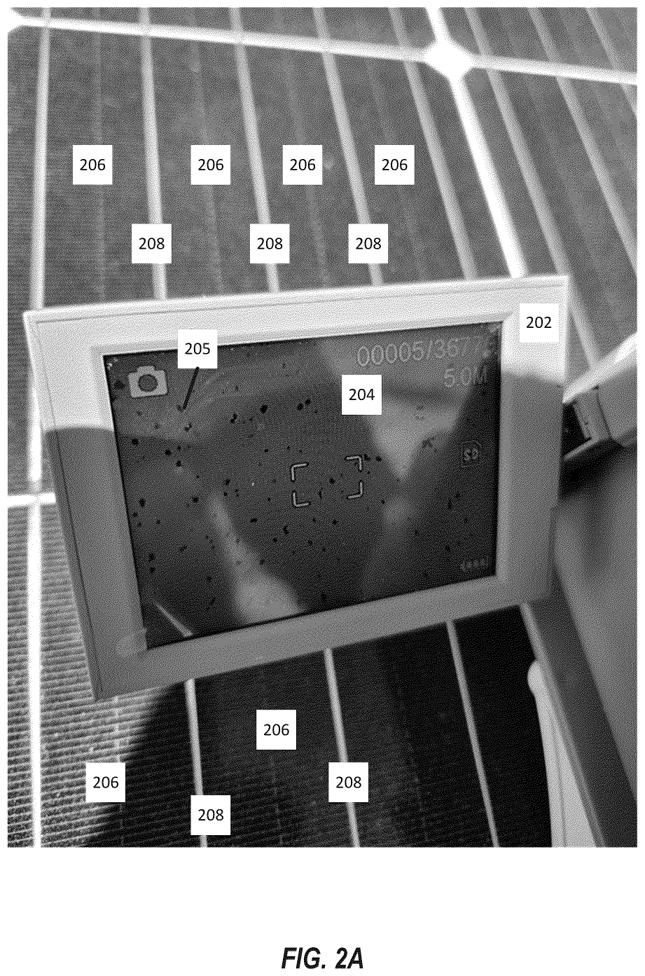

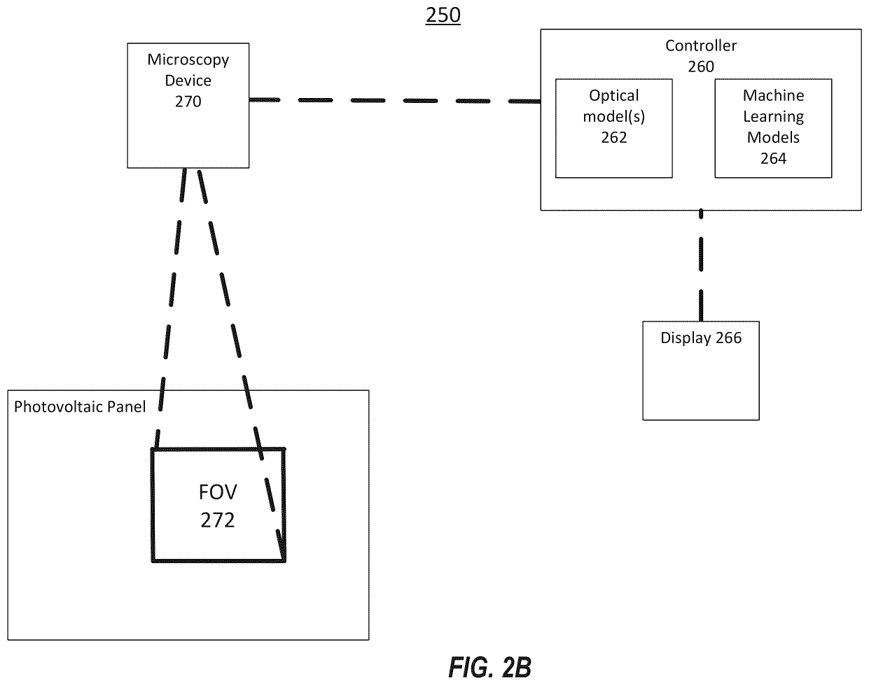

In some implementations, the microscopy device can be used to take an image of a surface other than the surface of the solar panel. For example, a translucent slide can be positioned over the solar panel to collect contaminants that would fall on the solar panel. The translucent slide can then be imaged by the microscopy device to measure the soiling losses of the translucent slide, and thereby estimate the soiling losses on some or all of the rest of the panel. Example implementations of microscopy devices that can be used to implement the methods of FIGS. 1A-1D are described with reference to FIGS. 2A and 2B herein.

Alternatively or additionally, a “proxy” device can be used in place of the solar panel. For example, a proxy solar device can be created using a background and/or a translucent covering for the background. The proxy device can be positioned near one or more solar panels so that the contamination of the proxy device can be measured as an estimate of the contamination of the one or more solar panels.

In some implementations, the image can be a composite or “combined” image. For example, a composite image can be optionally created by “stacking” multiple images with different focal points to create a single image with a greater depth of field. Alternatively or additionally, a composite image can optionally be created by joining one or more images to form a wide angle image, or by “stacking” multiple images with different spectra/exposures. Any number of composite images can be created, for example a single composite image can optionally be created for an entire solar panel.

A microscopy device is defined as an device configured to capture images of contaminants. Additional description of microscopy devices is provided herein, for example with reference to FIGS. 2A-2B.

The surface of the photovoltaic panel can include any surface from which energy from the sun must hit or pass through to generate electrical energy. This can be any face of the surface—including the backside, which on a photovoltaic device (solar panel) can optionally be oriented towards the ground and/or horizontally. This can optionally be used to cover soiling losses on bi-facial modules (solar panels with solar cells on both sides of the panel).

In some implementations of the present disclosure, a single image of a single solar device can be taken to get representative images of an array of solar devices. Alternatively or additionally, a single image of multiple solar devices can be taken; and/or multiple images from different parts of an individual solar device can be taken; and/or multiple images of different parts of several solar devices can be taken. Alternatively or additionally, a time series can be collected by capturing images of the same area or areas of a solar device or devices to analyze changes over time.

At step 104, the image can be input to a software application. Optionally, the software application is configured as part of a cloud computing network or other network, or configured to access a network that the image is uploaded to. Alternatively or additionally, other data can be uploaded to the software application (e.g., metadata related to the image).

The data and image can include raw or processed image files. The cloud can be any database. Optionally the upload can be either remote data transfer or manually downloaded/uploaded.

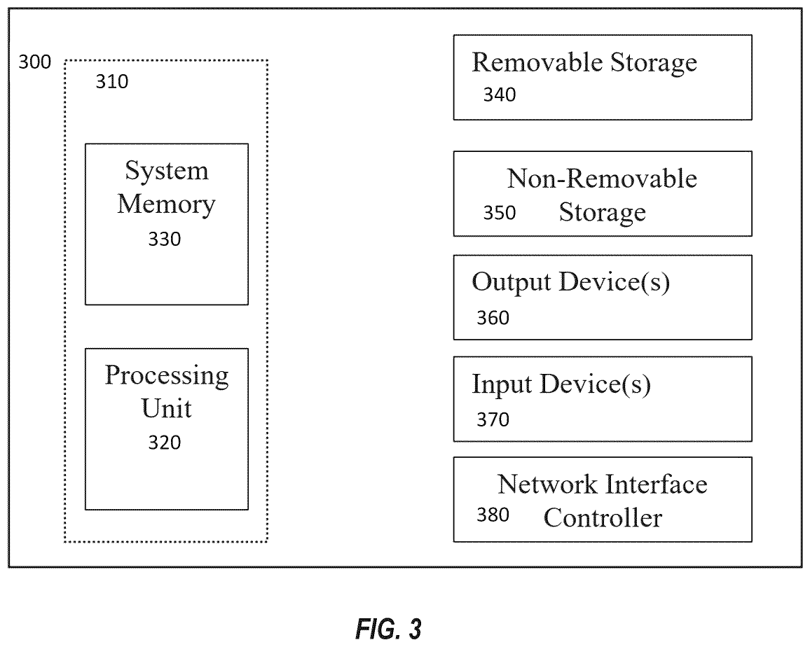

In some implementations of the present disclosure, the software is configured to run on a computing device that is part of the microscope. In some implementations, the software can be configured to run on a computing device that is operably connected to the microscope (e.g., by the networking device described with reference to FIG. 3.

In some implementations of the present disclosure, the microscope can be implemented using a camera or phone. Optionally, a microscope lens can be configured to attach to a camera or phone and used to acquire the images and/or any other data described herein. Again, it should be understood that the methods described herein can be implemented using any combination of computing and/or imaging devices.

At step 106, analysis is performed to determine an estimate of soiling based on the image. Analysis can include determining the amount, number, and/or coverage of particles, as well as any properties about the particles (color, shape, size, morphology, distribution, etc.).

Alternatively or additionally, the analysis at step 106 can include inputting an analyzed image into a soiling model (e.g., a machine learning model described herein). For example, the image analysis at step 106 can include measuring an amount of the image that is covered by a contaminant (e.g., dust) and then using the soiling model to estimate the soiling loss caused by the contaminant.

Alternatively or additionally, the analysis can include performing a change detection analysis. A time series of images can optionally be acquired, and compared to determine a rate of soiling and/or change in soiling.

In some implementations of the present disclosure, step 106 can include using soiling information obtained from another method to train a model that uses machine learning. Non-limiting examples of machine learning include AI, a convolutional neural network, or a statistical method to calculate soiling loss from images.

Optionally, the analysis can be performed by a computing device that is configured as part of the network or cloud computing network. Optionally, the analysis can be based on additional information, for example any other data uploaded to the software application.

In some implementations, step 106 can include image analysis as described in greater detail with reference to the method 160 of FIG. 1C. While FIG. 1C illustrates methods of determining an area covered by particles and/or an associated soiling loss caused by the particles, it should be understood that the image analysis can alternatively or additionally include determining a mass, area, composition, optical property and/or any other property of the particles. Alternatively or additionally, the image analysis at step 106 can include determining a morphology of the particles or relationships/combinations between the articles (e.g., determining whether particles are stacked, touching side-by-side, etc.) The custom image analysis can determine the size of each particle present in the image. Optionally, this can include ‘finding’ particles within the image and determining their size.

Optionally, step 106 can also include finding the total number of particles present in the image, or collection of images, and/or calculating the number of images in different size ‘bins’. A bin can be a size range of particles. As non-limiting examples, particles that are between 1 and 2 micrometers in diameter, or 15 and 20 micrometers in diameter.

Step 106 can further include calculating the mass per area of particles in each size bin using an assumption of spherical particles and the assumed density of particles within that size bin.

In some implementations, the mass loading from all the size bins can be summed. Alternatively or additionally, total mass loading of all the size bins up to an upper limit of size can be summed. Alternatively or additionally, an optical loss model can be applied. As used herein, the term “optical model” can refer to a model that applies an optical theory to estimate light extinction caused by particles. A non-limiting example of an optical loss model is a model based on Mie Theory, but it should be understood that other models, including, for example, other models of scattering are contemplated by the present disclosure. The optical loss model can be applied to the mass loading of each size bin to obtain an estimated light extinction associated with particles of that size. Additional optical methods include scattering, reflection, refraction, absorption, and/or any other model that model show light can interact with one or more particles.

In some implementations, the mass loading values described herein can be calibrated using actual soiling losses. Non-limiting examples of ways to measure or estimate actual soiling losses include soiling sensors, IV curve traces, data analytics, cleaning performance gain calculations, partial site cleanings, and a clean vs. dirty reference system.

In some implementations, the mass loading numbers can be replaced with an alternative metric. Non-limiting examples of alternative metrics that can be used include particle number, surface area loading, and surface area coverage.

Optionally, in some implementations, the analysis performed at step 106 can be performed without splitting particles into bin sizes.

In some implementations, the analysis can include adjusting any or all of the calculations and assumptions described herein, it should be understood that the particular numbers and orders of steps are intended only as non-limiting examples. For example, the present disclosure can be applied to different particle properties.

At step 108 the estimate of soiling can be saved to a database and/or displayed to a user. Soiling loss information is presented to the user on the software, application, the device, an email or text alert, or by any other computing device, as described with reference to the computing device 300 shown in FIG. 3.

The example method 100 shown in FIG. 1A can be performed for any photovoltaic (PV) device capable of converting sunlight into electrical energy. It should also be understood that the method 100 can be applied to other devices, for example any device that uses mirrors to direct sunlight or a lens to concentrate sunlight. It should also be understood that a solar site or solar panel can be a single device, or an array of devices, and that the present disclosure can be used for all types of photovoltaic devices and concentrating solar thermal devices.

Implementations of the present disclosure can include improvements to existing methods for measuring soiling on-site and can be used in combination with any/all of those methods. For example, implementations of the present disclosure can be used in conjunction with other on-site soiling sensors; IV curve tracing (which involves measuring the output of a panel or several panels and comparing it against a clean reference measurement); a partial site cleaning and corresponding comparison of this clean reference with a soiled portion; and/or using data analytics to estimate soiling losses. Optionally, the estimate of soiling losses can include an estimate of future soiling losses.

FIG. 1B illustrates an example method 150 for training a machine learning model to estimate a soiling loss according to implementations of the present disclosure. The method 150 includes estimating a soiling loss at step 152, calibrating a metric based on the soiling loss at step 154, and training a model to estimate soiling loss based on at least the soiling loss and the metric at step 156. Optionally, the metric can include at least one of particle size, mass loading or area loading. The metric calibrated at step 154 can optionally be calibrated using statistical methods without using a machine learning model.

FIG. 1C illustrates an example image analysis method 160 that can be used in implementations of the present disclosure. For example, the method 160 of FIG. 1C can be used to perform the image analysis at step 106 in FIG. 1A.

At step 162 the method can include receiving an input image including pixels. Non-limiting examples of input images that can be captured by a microscopy device are shown in FIGS. 5A and 6A.

At step 164, the method can include setting, for each of the pixels, a value. Optionally, the value can be a value between 0 and 255 (e.g., an 8-bit image) but any value can be used. The value can represent a property of the pixels (e.g., brightness, color, etc.) or combinations of pixel properties.

At step 166, the method can include setting a scale for the image and/or pixels. Optionally, the scale can be represented as a ratio between a distance in world space and a number of pixels. For example, the scale can be set as a number of microns per pixel.

At step 168, the method can include applying a particle threshold to the values to generate a thresholded image. The particle threshold can represent a rule used to determine what a particle is in the image. Non-limiting examples of thresholding include Max Entropy, Otsu, Renyi Entropy, Shanbhag, etc. The thresholding can also be performed by selecting a specific pixel value for the cutoff to include/exclude. The result of applying the particle threshold to the values can be an thresholded image where each pixel is assigned one of two values based on the threshold (e.g., black or white, 0 or 255, etc.) Non-limiting example thresholded images are illustrated in FIGS. 5C, 5D, and 6B.

At step 170, the method can optionally include filling holes in the thresholded image. Filling holes can include determining areas of the thresholded image that are surrounded by pixels of a different type (e.g., white pixels surrounded by black pixels) and assigning the surrounded pixels the value of the pixels that surround them (e.g., changing surrounded white pixels into black pixels). A non-limiting example of an image with holes filled is shown in FIG. 6C.

At step 172, the method can further include performing a watershed operation. A watershed operation can identify areas of the thresholded image that represent discrete particles. The watershed operation can further include modifying the pixels at the boundary between discrete particles to visually separate discrete particles on the image. For example, two particles may be colored black in a thresholded image, and touch, so that the two particles are seen as a contiguous black area of the thresholded image, and a watershed operation can separate the two particles by adding white pixels between the two black particles. Non-limiting examples of watershed operation include Marker-controlled watershed algorithms, Meyer's watershed algorithm, and Tiled watershed algorithms. A non-limiting example of an image with a watershed operation applied is shown in FIG. 6D.

At step 174, the method can optionally further include filtering the thresholded image. The filtering can include filtering using size and/or circularity to detect particles on the image.

At step 176, the method can further include determining, based on the detected particles in the image, a mass distribution of the detected particles in the image.

Optionally, step 176 can further include measuring other particle properties as alternatives or additions to the mass distribution. Optionally, the method can include measuring an area of the image covered by the detected particles (e.g., in micrometers squared). Optionally, the method can include measuring the area of one or more of the detected particles, and/or the total area of the detected particles. The area of the detected particles and/or total area can be used to estimate the soiling losses of the panel that the image is acquired from. A non-limiting example of an image where areas covered by detected particles has been measured is in FIG. 5E.

Alternatively or additionally, the method can include determining the total particle count, and/or particle size distribution.

Alternatively or additionally, determining which features in an image are a particle can include Adaptive Thresholding); segmentation (e.g., k-means clustering); Edge Detection (e.g., Canny edge detector, Sobel filter, and/or Laplacian methods used to identify boundaries of particles); Region Growing (method starts with seed points and grows the region by appending neighboring pixels that have similar properties, where region growing is a controlled approach for particle isolation, allowing for precise control over the criteria that dictate whether a pixel is included in a region); Mathematical Morphology (e.g., advanced morphological techniques can be employed to refine particle isolation. This can include using custom structuring elements or sequential operations that are tailored to the specific shapes and sizes of particles expected in the image); Fourier Transform Analysis, (transforming the image into the frequency domain using Fourier transforms. High-frequency components often correspond to edges and detailed features, which can be isolated and manipulated to enhance particle detection), Active Contours/Snakes (Active contours, commonly known as snakes, are a method for outlining an object within an image).

At step 178, the method can include outputting an estimate of soiling losses. Optionally, the estimate of soiling losses is based on an optical model, and/or machine learning model that relates any or all of the particle properties measured a step 176 to the soiling loss of the solar panel.

Alternatively or additionally, the estimate of soiling losses can be determined based on area covered by one or more particles, the mass or combined mass of one or more particles, or any combination of the particle properties described with reference to step 176.

FIG. 1D illustrates an example method 180 of image analysis, according to an example implementation of the present disclosure. The example method 180 shown in FIG. 1D can be used to perform the analysis described with reference to step 106 of FIG. 1A.

At step 182, the method includes receiving an image. The image can be any of the types of images described herein, for example with reference to step 102 of method 100 shown in FIG. 1A. Non-limiting examples of input images that can be captured by a microscopy device are shown in FIGS. 5A and 6A.

At step 184, the method can optionally include performing a watershed operation on the image to output a segmented image. Examples of watershed operations are described with reference to Step 172 of FIG. 1C. The segmented image is an image that identifies the boundary between discrete particles. A non-limiting example of a segmented image from a watershed operation is shown in FIG. 6D. It should be understood that a watershed operation is intended only as a non-limiting example of a segmentation algorithm that can be used according to implementations of the present disclosure to identify separate particles in an image. It should be understood that in some implementations of the present disclosure, the image can be processed without segmentation, for example by filtering the image received at step 182 or by determining a property of the particles at step 188 without first segmenting the image.

Optionally, the method includes filtering the segmented image. As used herein, filtering can include any combination of selecting particles in the segmented image using size, circularity, and/or other geometry of areas in the segmented image. Filtering the segmented image can be used to detect particles in the segmented image by identifying spaces between distinct particles.

At step 188, the method includes determining, based on the detected particles in the image, a property of the detected particles. As described with reference to step 106 of FIG. 1A, example particle properties can include a mass, area, composition, optical property and/or any other property of the particles. An example image with estimates of areas covered by particles is shown in FIG. 5E.

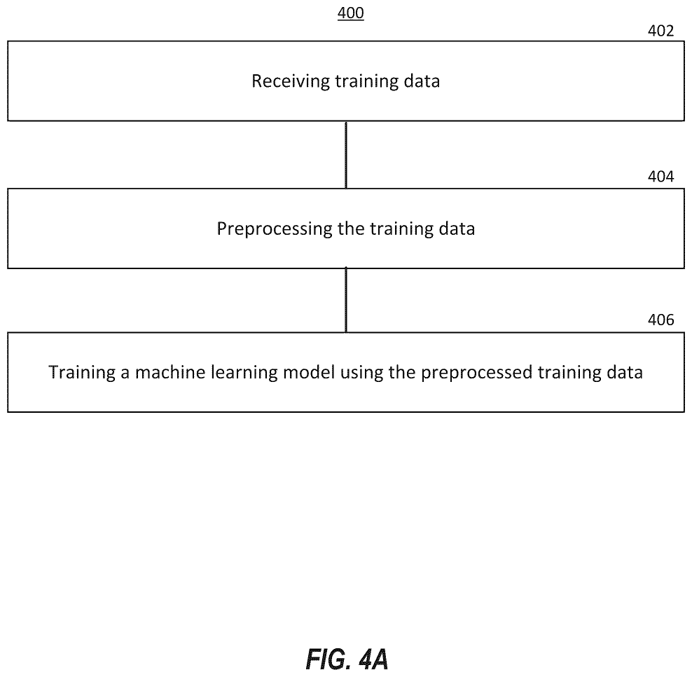

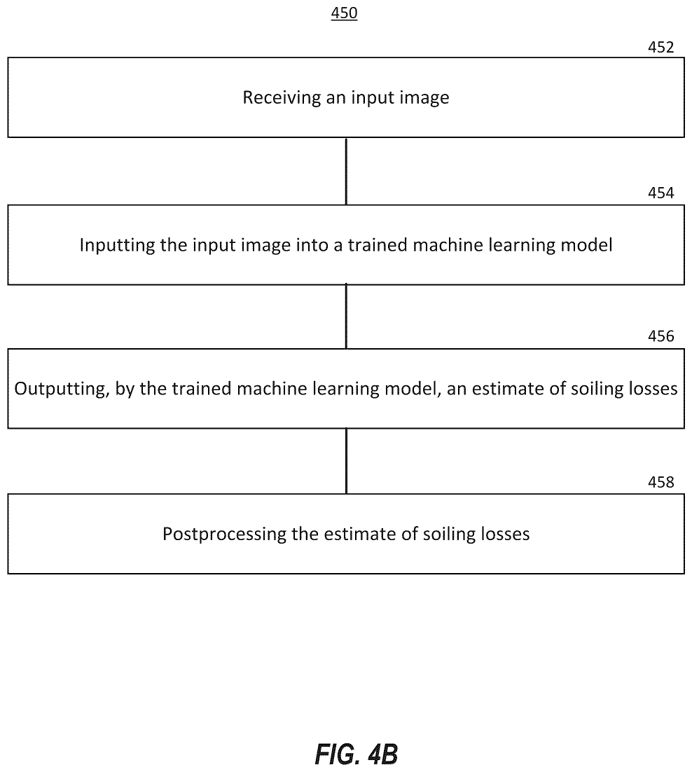

At step 190, the method includes outputting, based on property of the detected particles, an estimate of soiling losses. As non-limiting examples, estimating soiling losses can optionally be based on the area covered (e.g., a percentage of the total area of a photovoltaic panel covered), particle mass, and/or by using any properties of the particles determined at step 188 as inputs to optical models and/or machine learning models as described herein with reference to step 106 of FIG. 1A and the methods described with reference to FIGS. 4B and 1B, for example.

With reference to FIG. 2A, an example microscopy device 202 is placed on an array of solar cells 206. The solar cells 206 are separated by spaces 208. In some implementations of the present disclosure, the microscopy device 202 can be used to take images of the spaces 208 between the solar cells 206. This can be used to show the particles 205 on a light background in the image 204 shown on the microscopy device 202. It should be understood that FIG. 2A is a non-limiting example, and that in various implementations of the present disclosure images can include any images that include contaminants that affect the solar cells. 206 The images can be taken of dark solar cells, over the light wire lines, and/or of the backside of the panel as additional non-limiting examples. As yet still additional examples, the solar panel or photovoltaic panel can be a “bifacial” solar panel. A bifacial solar panel can have gaps between solar cells and be configured to generate power from both sides of the solar panel. The imaging devices (including the microscopy device 202) described herein can optionally be positioned on either or both sides of the bifacial solar panel, and/or configured to image contaminants on the transparent space between cells of a bifacial solar panel.

FIG. 2B illustrates an example system that can be used to measure soiling losses according to any of the methods described with reference to FIGS. 1A-1D and 4A-4B. The system 250 includes a microscopy device 270.

In some implementations, the microscopy device 270 can be a device that is configured to resolve the particles that make up contaminants on a solar panel. Resolving the particles that make up the contaminants on the solar panel can be used in implementations of the present disclosure to estimate a mass of the contaminant particles, (either individually or total, for example). Optionally, the particles can be resolved at a sufficient resolution to estimate the shape of the particles (e.g., measure a circularity of the particle). Implementations of the present disclosure can improve over existing methods of remote sensing and imaging by using images that have sufficient resolution to determine properties of the particles that can be used for the methods and system described herein. For example, particle mass, particle circularity/geometry, and particle size can all be used as inputs to models (e.g., optical and machine learning models) to determine the effect that the particles have on light reaching a photovoltaic panel. Methods that do not include sufficient resolution to determine the shape, size, mass, or other properties of the particles can be limited because particle properties can be useful inputs to machine learning and optical models, and can increase the accuracy of those models for determining soiling losses and otherwise measuring contaminants on a photovoltaic panel, as described herein.

As a non-limiting example, in some implementations, a microscopy device 270 can be a device that can be configured to resolve particles of 20 microns or less in diameter.

As a non-limiting example, in some implementations a microscopy device 270 can be a device that can be configured to resolve particles of 25 microns or less in diameter (e.g., types of large dust particles).

As a non-limiting example, in some implementations, the microscopy device 270 can be a device configured to resolve particles less than 20 microns in diameter.

As yet another non-limiting example, in some implementations a microscopy device 270 can be a device can be a device configured to resolve particles of 25 microns or greater (e.g., types of pollen grains, funguses).

Alternatively or additionally, the microscopy device 270 can be an imaging device that is configured to capture images with a resolution of less than 100 microns per pixel.

Microscopy devices 270 can be implemented using various combinations of sensors and optics to achieve the microns-per-pixel ranges described herein. For example, a microscopy device can be implemented using a lens and imaging sensor with a high magnification. Alternatively or additionally, a microscopy device can be implemented using a very high resolution sensor. As yet another example, a microscopy device can be implemented by positioning the lens and/or sensor close enough to the solar panel that the desired resolution is achieved. It should be understood that combinations of these techniques can also be used. For example, a digital microscope can be used to image a small section of a solar panel at a high magnification and resolution, to achieve an image with a small number of microns-per-pixel (high resolution).

It should also be understood that the techniques described herein can be applied to video, and that the microscopy device 270 can optionally be configured to capture video of the solar panel.

As shown in FIG. 2B, the field of view 272 (FOV) of the microscopy device 270 can be defined as the dimensions of the solar panel that are imaged by the microscopy device 270. It should be understood that that field of view 272 can cover any portion of a solar panel, and that the microscopy device 270 can be any distance from the photovoltaic panel.

An additional non-limiting example configuration of microscopy device 270 includes a device configured to take images with a resolution of approximately 1 micrometer per pixel, and/or images with a field of view of approximately 2.5 millimeters by 2.5 millimeters.

An additional non-limiting example configuration of microscopy device 270 includes a device configured to take images with a images with a field of view of less than or greater than 2.5 millimeters by 2.5 millimeters.

An additional non-limiting example configuration of microscopy device 270 includes a device configured to take images with a images with a field of view of less than or greater than 50 millimeters by 50 millimeters.

The microscopy device 270 can optionally be implemented as a standalone device, a device that connects to a computer, or the use of two separate devices—a camera capturing images/video through a separate microscope or microscope lens.

Still with reference to FIG. 2B, the system 250 can include a controller 260. The controller 260 can include any or all of the components of the computing device 300 described with reference to FIG. 3. The controller 260 can be coupled to the microscopy device 270 using any combination of wired/wireless couplings, including, for example, network devices.

The controller 260 can optionally include an optical model 262 and/or trained machine learning model 264 as shown in FIG. 2B. Alternatively or additionally, the controller 260 can include a physical model (not shown). The controller can be configured to implement the methods described herein, for example with reference to FIGS. 1A-1D, to train machine learning models, and/or output estimates of soiling loss using any combination of the optical model 262 and/or machine learning models 264. It should be understood that any combination of physical model, optical model, and machine learning models can be used in implementations of the present disclosure, and that some implementations of the present disclosure may not include physical models, optical models, and/or machine learning models.

The controller 260 can further be optionally coupled to a display 266. The display 266 can be configured to output a measure of soiling loss and/or images of the photovoltaic panel. Optionally, the display can be configured to output images that have been processed (e.g., by watershed methods, thresholding methods, segmentation methods, etc.) as described herein with reference to FIGS. 1A-1D. Example images that can be generated and/or output according to the methods described herein are shown in FIGS. 5A-6D.

FIG. 4A illustrates a flowchart of a method 400 of training a machine learning model to estimate soiling losses. Optionally, the model can include a convolutional neural network.

At step 402, the method can include receiving training data. The training data can include any combination of microscope images, and external soiling estimations (on-site sensors, data monitoring platforms), including, for example, the images described with reference to the systems and methods of FIGS. 1A-2B.

The present disclosure contemplates that the training data can be collected using any of the imaging devices described herein, for example with reference to step 102 of FIG. 1A (e.g., digital cameras, sensors, monitoring platforms). Any amount of data can be used. Optionally, greater than 500 images are included in the training data. The training data can be formatted using any image format (e.g., jpg, png, tiff, etc.) and estimates of soiling can be

At step 404, the method includes preprocessing the training data. Preprocessing can optionally include random flips (e.g., horizontal flips) to the images in the training data.

In some implementations, preprocessing the training data can include converting images in the training data into 8-bit images, and converting the 8-bit image to a binary image by thresholding to isolate particles.

In some implementations, preprocessing can include aggregating multiple images, and/or transforming multiple images from the training data.

In some implementations, external soiling estimations can be used to train the model, and one or more images in the training data can be correlated with an external soiling estimation corresponding to the image(s).

At step 406, the method includes training the machine learning model using the preprocessed training data to estimate a soiling loss for a solar panel based on an input image. Optionally, the machine learning model can be a convolutional neural network (CNN) and/or supervised learning model. In some implementations the CNN can use transfer learning, including a pre-determined architecture and training model weights for it.

It should be understood that the machine learning methods described herein can be used to train machine learning models to perform additional types of machine learning analysis of contaminants. For example, in some implementations the machine learning models described herein can be trained to identify presence of fungus, fungus type, extent of fungus cover, etc. on images of solar panels; to identify presence of pollen, pollen type, extent of pollen cover, etc. on images of solar panels; and/or to identify the presence of mold, dust, organic carbons, and other naturally deposited or biological growth on the panels.

With reference to FIG. 4B, implementations of the present disclosure include methods 450 of using trained machine learning models to output estimates of soiling losses.

At step 452, the method can include receiving an image of a solar panel and a contaminant.

At step 454, the method can include inputting the image into a trained machine learning model (e.g., the trained machine learning model trained according to the method 400 of FIG. 4B).

At step 456, the method can include outputting, by the trained machine learning model, an estimate of soiling losses for an area of the image.

At step 458, the method can include postprocessing the estimate of soiling losses from step 456. Example postprocessing steps can include performing a regression and/or classification. Non-limiting examples of classification include high soiling, mild soiling, presence of specific soiling species, etc.

With reference to FIG. 5A-5E, non-limiting examples of image processing are shown according to implementations of the present disclosure. FIG. 5A illustrates an unprocessed image that can be output by a microscopy device (e.g., the microscopy device 270 described with reference to FIG. 2B). FIG. 5B illustrates the image of FIG. 5A, converted to be an 8-bit image (e.g., an 8 bit color image). FIG. 5C illustrates an example thresholded image obtained by applying an example thresholding operation to FIG. 5B. FIG. 5D shows an example output of thresholding for particle identification/isolation. FIG. 5E illustrates an example calculation of the areas of particles identified in the thresholded image of FIG. 5D.

With reference to FIGS. 6A-6D, non-limiting examples of image processing are shown according to implementations of the present disclosure. FIG. 6A illustrates an example unprocessed image that can be output by a microscopy device (e.g., the microscopy device 270 described with reference to FIG. 2B). FIG. 6B illustrates a second example of a thresholded image using the unprocessed image shown in FIG. 6A. FIG. 6C illustrates an example fill holes operation applied to the thresholded image of FIG. 6B. FIG. 6D illustrates an example watershed operation applied to the image of FIG. 6C.

It should be understood that the thresholds, colors, scales, and other attributes of the images illustrated in 5A-6D are intended only as non-limiting examples. For example, in some implementations contaminants are lighter colored than the background (e.g., light-colored dust on a dark photovoltaic panel) so that the image is processed by detecting light-colored contaminants against a dark background. Alternatively or additionally, contaminants can be any color, or any number of colors, and implementations of the present disclosure can be configured to different contaminants against different backgrounds. It should also be understood that the number and order of the steps shown in FIGS. 5A-6D is only a non-limiting example, and that implementations of the present disclosure can use more than, or fewer steps than the ones illustrated in FIGS. 5A-6D.

It should also be understood that the methods described herein can be performed repeatedly and/or iteratively to identify particles with different properties. As a non-limiting example, the methods described herein could be configured to detect light particles, and estimate a property (e.g., area, mass, or any other property described herein) of the light particles. The methods described herein could again be configured to detect dark particles, and compute a property (e.g., area, mass, or any other property described herein) of the light particles.

The methods described herein could then be configured to detect any other color of particles and estimate a property (e.g., area, mass, or any other property described herein) of the other colored particles. It should be understood that light/dark particles can be detected in any order, and that the methods described herein can be performed any number of times to determine properties of particles with any colors. The present disclosure contemplates that the estimates from any number of image analyses using methods described herein can be combined to estimate an overall soiling loss based on any number of images and/or image analyses.

Alternatively or additionally, it should be understood that the systems and methods described herein can be used for forecasting soiling losses, determining when one or more panel(s) should be cleaned, determining when to replace one or more panel(s), and any other decision related to the maintenance of a photovoltaic panel or photovoltaic panels. It should be understood that implementations of the present disclosure can therefore be applied to single panels, groups of any numbers of panels, and/or all panels at a site (e.g., a photoelectric power station including any number of panels).

In some aspects, an implementation of the present disclosure includes receiving, at a computing device, an image of a surface of a solar panel; analyzing, using the computing device, the image to determine an estimate of soiling losses; outputting, using the computing device, the estimate of soiling losses; and in response to the estimate of soiling losses cleaning the photovoltaic panel.

Referring to FIG. 3, an example computing device 300 upon which implementations of the disclosure may be implemented is illustrated. For example, the controller system or one or more of the controller blocks described herein may each be implemented as a computing device, such as computing device 300. It should be understood that the example computing device 300 is only one example of a suitable computing environment upon which implementations of the disclosure may be implemented. Optionally, the computing device 300 can be a well-known computing system including, but not limited to, cloud-based head end systems. personal computers, servers, handheld or laptop installation devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In an implementation, the computing device 300 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an implementation, virtualization software may be employed by the computing device 300 to provide the functionality of a number of servers that is not directly bound to the number of computers in the computing device 300. For example, virtualization software may provide twenty virtual servers on four physical computers. In an implementation, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party Software-As-A-System (SaaS) provider.

In its most basic configuration, computing device 300 typically includes at least one processing unit 320 and system memory 330. Depending on the exact configuration and type of computing device, system memory 330 may be volatile (such as random access memory (RAM)), non-volatile (such as read-only memory (ROM), flash memory, etc.), or some combination of the two. This most basic configuration is illustrated in FIG. 3 by dashed line 310. The processing unit 320 may be a standard programmable processor that performs arithmetic and logic operations necessary for operation of the computing device 300. While only one processing unit 320 is shown, multiple processors may be present. Thus, while instructions may be discussed as executed by a processor, the instructions may be executed simultaneously, serially, or otherwise executed by one or multiple processors. The computing device 300 may also include a bus or other communication mechanism for communicating information among various components of the computing device 300.

Computing device 300 may have additional features/functionality. For example, computing device 300 may include additional storage such as removable storage 340 and non-removable storage 350 including, but not limited to, magnetic or optical disks or tapes. Computing device 300 may also contain network connection(s) 380 that allow the device to communicate with other devices such as over the communication pathways described herein. The network connection(s) 380 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing device 300 may also have input device(s) 370 such as a keyboards, keypads, switches, dials, mice, track balls, touch screens, voice recognizers, card readers, paper tape readers, or other well-known input devices. Output device(s) 360 such as a printers, video monitors, liquid crystal displays (LCDs), touch screen displays, displays, speakers, etc. may also be included. The additional devices may be connected to the bus in order to facilitate communication of data among the components of the computing device 300. All these devices are well known in the art and need not be discussed at length here.

The processing unit 320 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 320 for execution. Example tangible, computer-readable media may include, but is not limited to, volatile media, non-volatile media, removable media and non-removable media implemented in any method or technology for storage of information such as computer readable instructions, data structures, program modules or other data. System memory 330, removable storage 340, and non-removable storage 350 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

In an example implementation, the processing unit 320 may execute program code stored in the system memory 330. For example, the bus may carry data to the system memory 330, from which the processing unit 320 receives and executes instructions. The data received by the system memory 330 may optionally be stored on the removable storage 340 or the non-removable storage 350 before or after execution by the processing unit 320.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Implementations of the methods and systems may be described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

While several implementations have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various implementations as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method of analyzing soiling losses, the method comprising:
receiving an image of a surface of a solar panel;
analyzing the image to determine an estimate of soiling losses; and
outputting the estimate of soiling losses.

2. The computer-implemented method of claim 1, further comprising at least one of forecasting energy production from the solar, assessing performance of the solar panel, and instructing a user to clean the solar panel or when to clean the solar panel.

3. The computer-implemented method of claim 1, wherein the image is a digital microscope image.

4. The computer-implemented method of claim 1, further comprising displaying the estimate of soiling losses to a user.

5. The computer-implemented method of claim 1, further comprising storing the estimate of soiling losses to a database.

6. A system for analyzing soiling losses, the system comprising:
a digital microscope; and
a computing device in operable communication with the digital microscope, wherein the computing device comprises a processor and a memory, the memory having computer-executable instructions stored thereon that, when executed by the processor, cause the processor to:
receive an image of a surface of a solar panel from the digital microscope;
analyze the image to determine an estimate of soiling losses; and
output the estimate of soiling losses.

7. A method for analyzing soiling losses, the method comprising:
generating an image of a surface of a solar panel;
inputting the image of a surface of the solar panel into a model;
analyzing, using the model, the image of a surface of the solar panel to determine an estimate of soiling losses; and
outputting, from the model, the estimate of soiling losses.

8. The method of claim 7, wherein the image is a digital microscope image.

9. The method of claim 7, further comprising displaying the estimate of soiling losses to a user.

10. The method of claim 7, further comprising storing the estimate of soiling losses to a database.

11. The method of claim 7, wherein the estimate of soiling losses comprises an estimate of future soiling losses.

12. A method of training a machine learning model to estimate soiling losses, the method comprising:
receiving training data comprising a plurality of images and corresponding soiling estimations for the plurality of images;
preprocessing the training data; and
training a machine learning model to estimate soiling loss based on at least the preprocessed training data.

13. The method of claim 12, wherein the soiling loss comprises at least one of particle size, mass loading or area loading.

14. The method of claim 12, wherein the soiling loss comprises an estimate of power loss.

15. The method of claim 12, wherein the machine learning model is a convolutional neural network.

16. The method of claim 12, wherein preprocessing the training data comprises performing random flips on one or more images.

17. The method of claim 12, wherein preprocessing the training data comprises a performing thresholding operation on the plurality of images.

18. The method of claim 12, wherein preprocessing the training data comprises aggregating at least two of the plurality of images into a composite image.

19. The method of claim 12, wherein preprocessing the training data comprises converting the plurality of images into binary images.

20. The method of claim 12, wherein preprocessing the training data comprises determining a plurality of pixel values for the plurality of images.
